(19) United States
(12) Patent Application Publication
(10) Pub. No.: US 2026/0116226 A1
(43) Pub. Date: Apr. 30, 2026

(54) CHARGEPLUG INTERFACE COMPONENTS AND METHODS

(71) Applicant: Cummins Inc., Columbus, IN (US)

(72) Inventors: Rishvanth Kora Venugopal, Bargersville, IN (US); Baylen Jobe, Columbus, IN (US); Kathika Baskar, Columbus, IN (US)

(21) Appl. No.: 19/372,960

(22) Filed: Oct. 29, 2025

Related U.S. Application Data
(60) Provisional application No. 63/713,309, filed on Oct. 29, 2024.

(51) Int. Cl. B60L 53/16; B60L 53/66; H01R 13/629; H01R 43/26

(52) U.S. Cl. CPC B60L 53/16; B60L 53/66; H01R 13/629; H01R 43/26; B60L 2240/80; H01R 2201/26

(57) ABSTRACT

A method for safe, autonomous unlocking of a chargeplug from an electrified vehicle during an active charge session, the method comprising receiving an indication of a compromised communication between a charge control unit (CCU) of an electrified vehicle (EV) and at least one of a system control module of the EV and Electric Vehicle Supply Equipment (EVSE) that is connectible to the EV for a charging session of an Energy Storage System of the electrified vehicle; and unlocking the chargeplug from the electrified vehicle in response to receiving the indication.

### CROSS REFERENCE TO RELATED APPLICATION

This application claims the benefit of U.S. Provisional Patent Application No. 63/713,309, filed on Oct. 29, 2024, the entire disclosure of which is incorporated by reference herein in its entirety.

### BACKGROUND

Chargeplugs (or charge guns) in electrified vehicles are components for efficient and effective charging of these vehicles. These chargeplugs are designed to enable a connection between the vehicle and a power source, which is typically an electric charging station. The chargeplug is designed to transfer electric power from the charging station to the vehicle's battery system, allowing the vehicle to recharge its batteries and extend its driving range.

### SUMMARY

In Example 1, a method for safe, autonomous unlocking of a chargeplug from an electrified vehicle during an active charge session, the method comprising: receiving an indication of a compromised communication between a charge control unit (CCU) of an electrified vehicle (EV) and at least one of a system control module of the EV and Electric Vehicle Supply Equipment (EVSE) that is connectible to the EV for a charging session of an Energy Storage System of the electrified vehicle; and unlocking the chargeplug from the electrified vehicle in response to receiving the indication.

In Example 2, the method as Example 1 describes, wherein the receiving the indication includes receiving the indication that corresponds to a control pilot signal.

In Example 3, the method as either of Examples 1 or 2 describe, wherein the control pilot signal indicates a change in state designation to an autonomously unlockable state.

In Example 4, the method as any of Examples 1-3 describe, wherein the autonomously unlockable state is one of State B1, State B2, and State C.

In Example 5, the method as any of Examples 1-4 describe, wherein the autonomously unlockable state corresponds to a state of an arrangement of resistors in a control pilot circuit.

In Example 6, the method as any of Examples 1-5 describe, wherein the arrangement of resistors includes a plurality of resistors.

In Example 7, the method as any of Examples 1-6 describe, wherein the plurality of resistors includes an EV side resistor on an EV side of the control pilot circuit.

In Example 8, the method as any of Examples 1-7 describe, wherein the plurality of resistors further includes an EVSE side resistor on an EVSE side of the control pilot circuit.

In Example 9, the method as any of Examples 1-8 describe, wherein the plurality of resistors further includes a second EV side resistor at the EV side of the control pilot circuit.

In Example 10, the method as any of Examples 1-9 describe, wherein the unlocking the chargeplug from the electrified vehicle in response to receiving the indication includes waiting a delay time before unlocking the chargeplug such that the chargeplug is able to be safely removed.

In Example 11, a vehicle inlet of a control pilot circuit for an electrified vehicle, the vehicle inlet including a pair of parallelly arranged resistors and a switch disposed between the pair, the vehicle inlet is configured to lockingly engage with a chargeplug of an Electric Vehicle Supply Equipment (EVSE) such that the chargeplug autonomously enters an unlocked state when a Charge Control Unit (CCU) has experienced a communication anomaly.

In Example 12, the vehicle inlet as Example 11 describes, wherein the communication anomaly indicates that a Charge Control Unit has lost communication with at least one of the EVSE and a System Control Module.

In Example 13, the vehicle inlet as either of Examples 11 or 12 describe, wherein the communication anomaly is indicated by a control pilot state.

In Example 14, the vehicle inlet as any of Examples 11-13 describe, wherein the vehicle inlet responds to a transition in the control pilot state by actuating the switch.

In Example 15, the vehicle inlet as any of Examples 11-14 describe, wherein the chargeplug autonomously enters the unlocked state after a delay time when the charge control unit has experienced the communication anomaly.

In Example 16, a controller for an energy storage system, the controller comprising one or more processors configured to autonomously direct a connectible chargeplug to enter an unlocked state during an active charging session upon receiving an indicator that there has been a communication anomaly related to the active charging session.

In Example 17, the controller as Example 16 describes, wherein the controller is configured to communicate with a resistor arrangement having a plurality of states, including an autonomously unlockable state and a locked state, the autonomously unlocked state corresponding to State B1, State B2, or State C.

In Example 18, the controller as either of Examples 16 or 17 describe, wherein the one or more processors is further configured to implement a delay time before causing the connectible chargeplug to enter the autonomously unlockable state.

In Example 19, the controller as any of Examples 16-18 describe, wherein the controller is integrated into an electrified vehicle.

In Example 20, the controller as any of Examples 16-19 describe, wherein the controller is further configured to be in communication with a control pilot circuit, and wherein the indicator corresponds to a voltage at the control pilot circuit.

### BRIEF DESCRIPTION OF THE DRAWINGS

FIG. 1 is a schematic diagram of a dual-axle multi-mode adjustable hybrid vehicle system with integrated front axle;

FIG. 2 is a schematic diagram of an integrated axle;

FIG. 3 is a schematic diagram of another dual-axle multi-mode adjustable hybrid vehicle system with integrated front axle;

FIG. 4 is a schematic diagram of an example of a three-axle multi-mode adjustable hybrid vehicle system with integrated front axle;

FIG. 5 is a schematic diagram of an example of a three-axle multi-mode adjustable hybrid vehicle system with integrated front axle;

FIG. 6 is a schematic diagram of an example of a three-axle multi-mode adjustable hybrid vehicle system with integrated front axle;

FIG. 7 is a schematic diagram of a controller operatively coupled with other components of the system;

FIG. 8 is an isometric view of a power source with a battery management system that is coupled to an electric or hybrid vehicle, according to an exemplary embodiment;

FIG. 9 is a diagram including a flowchart of a sequence for operating a chargeplug according to a first sequence, Sequence 1; and

FIG. 10 is a diagram including a flowchart of a sequence for operating a chargeplug according to a second sequence, Sequence 2.

### DETAILED DESCRIPTION

For purposes of promoting an understanding of the principles of the present disclosure, reference is now made to the embodiments illustrated in the drawings, which are described below. The exemplary embodiments disclosed herein are not intended to be exhaustive or to limit the disclosure to the precise form disclosed in the following detailed description. Rather, these exemplary embodiments were chosen and described so that others skilled in the art may utilize their teachings. It is not beyond the scope of this disclosure to have a number (e.g., all) the features in a given embodiment to be used across all embodiments.

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present disclosure. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Electrified vehicles are a type of transportation technology that utilizes electricity as its main source of power. This technology is becoming increasingly popular due to its environmental benefits and cost-effectiveness. Electrified vehicles include fully electric vehicles, hybrid electric vehicles, and fuel cell electric vehicles. Principles of the present disclosure are applicable in whole or in part to each of these vehicles.

Fully electric vehicles are powered solely by electricity and do not require any gasoline or diesel fuel. These vehicles use rechargeable batteries to store energy, which is then used to power the electric motor. Fully electric vehicles are environmentally friendly, producing zero emissions and requiring less maintenance than traditional gasoline-powered vehicles.

Hybrid electric vehicles combine an electric motor with a gasoline or diesel engine. These vehicles use the electric motor for low-speed driving and the gasoline or diesel engine for high-speed driving. Hybrid electric vehicles are more fuel-efficient than traditional gasoline-powered vehicles and produce lower emissions.

Fuel cell electric vehicles use hydrogen as their main source of energy. The hydrogen is converted into electricity through a fuel cell, which powers the electric motor. Fuel cell electric vehicles produce zero emissions and are highly efficient, making them an environmentally friendly option for transportation. However, the infrastructure for hydrogen fueling stations is still limited, making it difficult for fuel cell electric vehicles to become mainstream.

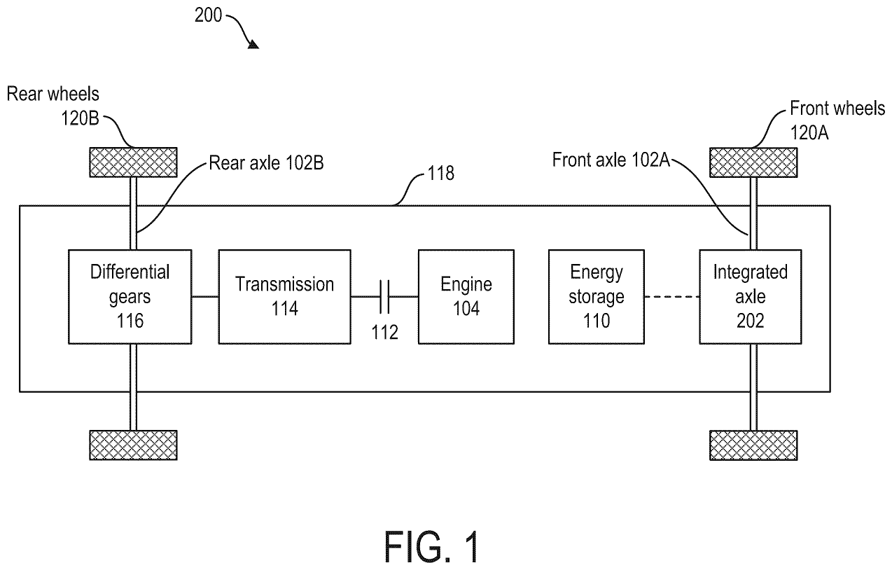

Now turning to the figures, FIG. 1 shows an example of a multi-mode hybrid vehicle system 200 as disclosed herein. The system 200 includes a plurality of motive power sources. For example, an integrated axle 202 is mechanically coupled with a steerable front axle 102A such that the integrated axle 202 is used as a motive power source to provide the motive force to drive the front wheels 120A using electrical energy provided form the energy storage 110. The rear axle 102B is mechanically coupled with the differential gears 116, which is mechanically coupled with the transmission 114, which is mechanically coupled with or decoupled from the engine 104 via the clutch 112. The rear axle 102B, therefore, is controlled using the motive force provided by the engine 104, another power motive source. For simplicity, the inverter(s) for the integrated axle 202 and the fuel reservoir 108 coupled with the engine 104 are not shown.

As disclosed herein, an “integrated axle” includes a type of electric axle drive that is affixed to the wheels 120 to rotate them. In examples, the integrated axle 202 combines the functionality of an electric motor-generator 300, power electronics such as an inverter, and in some examples a cooling circuit to reduce cost and increase efficiency in a single component. Integrated axles 202 are neither directly nor indirectly coupled with any combustion engine, thereby using solely the motor-generator included therein to provide mechanical power to a drive axle coupled thereto.

In some examples, the motor-generator 300 of the integrated axle 202 may be mounted on the drive axle 102. In some embodiments, the integrated axle is configured to reduce interfaces and components that may induce efficiency loss. Examples of such components include wires and copper cables that link the components together, plugs, bearings for rotating components, and separate cooling circuits for the electric motor 300 and power electronics. The integrated axles 202 are also more compact than the electric motor 300, the power electronics, and the cooling circuits therefore being individually installed, thus saving installation space within the chassis frames of the vehicle and allowing more room therein. Each integrated axle 202 is configured independently of other sat(s) in the system. In some examples, the integrated axle 202 may also include a two-speed or three-speed gearbox.

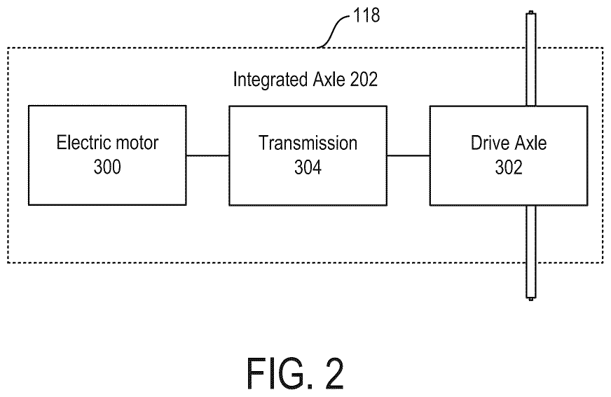

As shown in the embodiment of FIG. 1, the integrated axle 202 is mechanically coupled with a drive axle 102, such as the front axle 102A as shown in FIG. 1. The drive axle 102 is mechanically coupled with a pair of wheels 120, such as the pair of front wheels 120A as shown in FIG. 1. Although not shown, a controller is electrically coupled with the integrated axle 202. Based on the inputs received, the controller turns on (activates or engages) or turns off (deactivates or disengages) one or more of these components to achieve the different modes shown herein. FIG. 2 shows some of the components of the integrated axle 202. For example, the integrated axle 202 includes an electric motor-generator 300, a drive axle 302, and a transmission 304. Other components such as the aforementioned inverter and/or cooling circuit may be included in the integrated axle 202, as suitable. These components are separately or independently operable from the other components (e.g., the transmission 304 is separately operable from the transmission 114). The components of the integrated axle 202 (e.g., the electric motor-generator and at least a portion of the drive axle, etc.) may be mechanically mated to, coupled to, affixed to, or implemented within a common housing 118. The housing 118 may be any suitable structure which supports the positioning of the components, as well as to provide protection of the components.

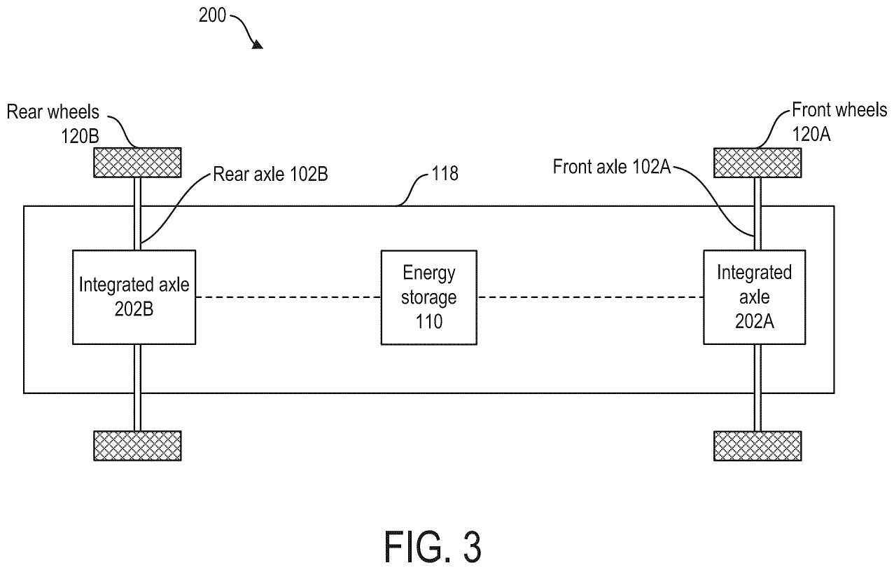

FIG. 3 shows an example of the system 200 which incorporates two integrated axles 202A and 202B, with one implemented for each of the front axle 102A and the rear axle 102B, respectively. The integrated axles 202A and 202B are operated using the controller (not shown) and the electrical energy for these axles 202A,202B are provided by a common energy storage 110, such as a battery or a battery pack. The two integrated axles 202A and 202B may be separately and independently operated so as to be implementable as two separate and distinct motive power sources. Each integrated axle 202 may include the same components, including for example an electric motor and a transmission as explained herein, that are separately operable from each other, although they may be operable together simultaneously as well, as suitably controlled by the controller.

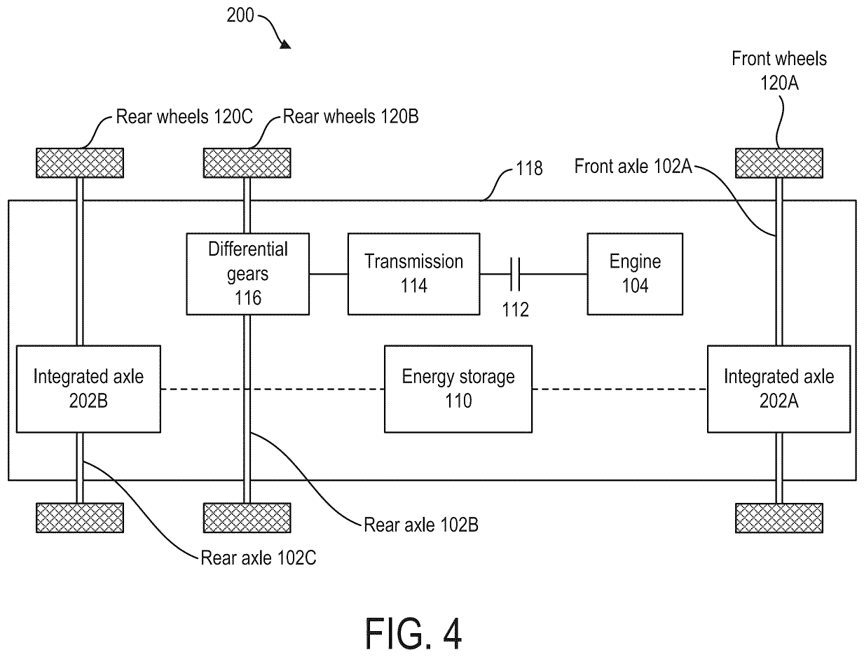

FIGS. 4 through 6 show examples of the system 200 where more than two axles (and in effect, more than four wheels) are implemented, with different combinations of integrated electrical axles and engine-powered axles implemented therein. It is to be understood that these figures are provided for illustrative purposes only, such that any additional number of axles may be implemented according to the need of the vehicle and its operation.

FIG. 4 shows an example of the system 200 which incorporates three axles 102A, 102B, and 102C, of which two of them, the front axle 102A and the rear axle 102C, have integrated axles 202A and 202B, respectively, coupled therewith. The other axle (rear axle) 102B is coupled with the engine 104 via the clutch 112, transmission 114, and differential gears 116 as shown. The integrated axles 202A and 202B are electrically powered by the energy storage 110.

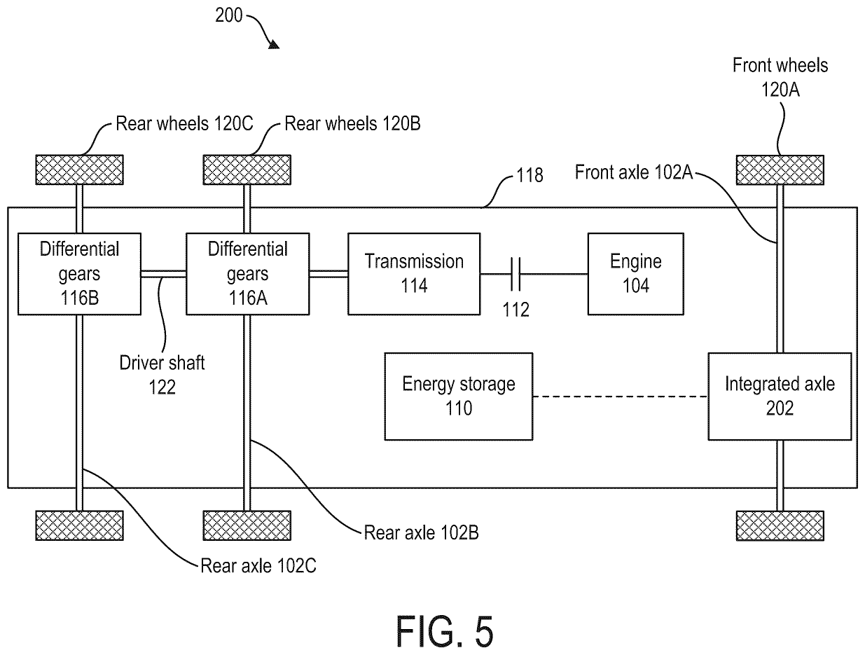

FIG. 5 shows an example of the system 200 with three axles 102A, 102B, and 102C, but instead of two integrated axles, only the front axle 102A is coupled with the integrated axle 202, and the two remaining rear axles 102B and 102C are coupled with differential gears 116A and 116B, respectively. The differential gears 116A and 116B are coupled with each other via the drive shaft 122 which may operate both of the gears simultaneously, using the power provided by the engine 104 and transferred through the transmission 114. As such, the rear axles 102B and 102C may be coupled with each other via the drift shaft 122.

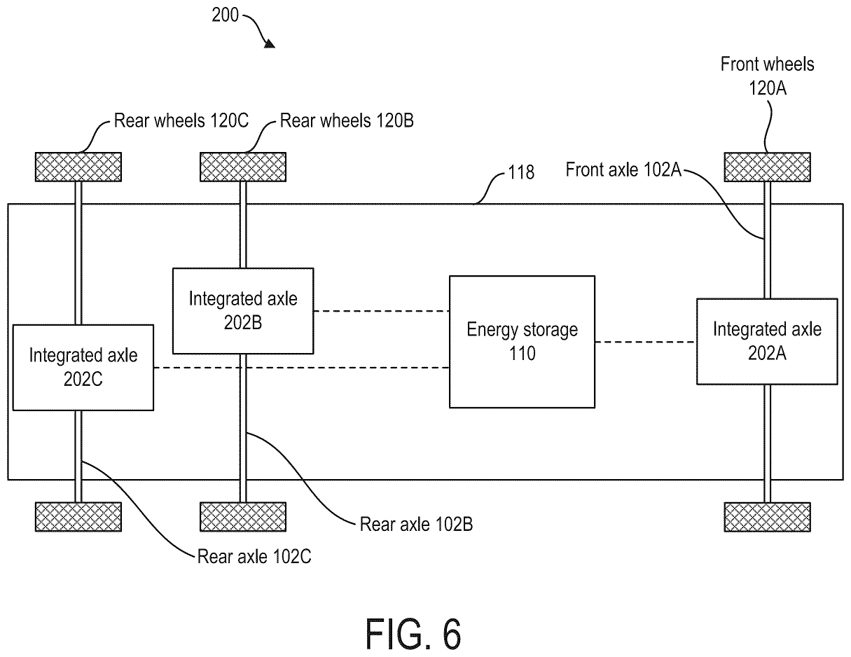

FIG. 6 shows an example of the system 200 with all three axles 102A, 102B, and 102C being powered electrically using the energy storage 110. That is, there are three integrated axles 202A, 202B, and 202C for the three axles, each independently operable, as controlled by a controller (not shown). In all examples disclosed herein, the front axle 102A is always implemented with an integrated axle, but the remaining axles may have integrated axles, engine-powered axles, or a combination of both.

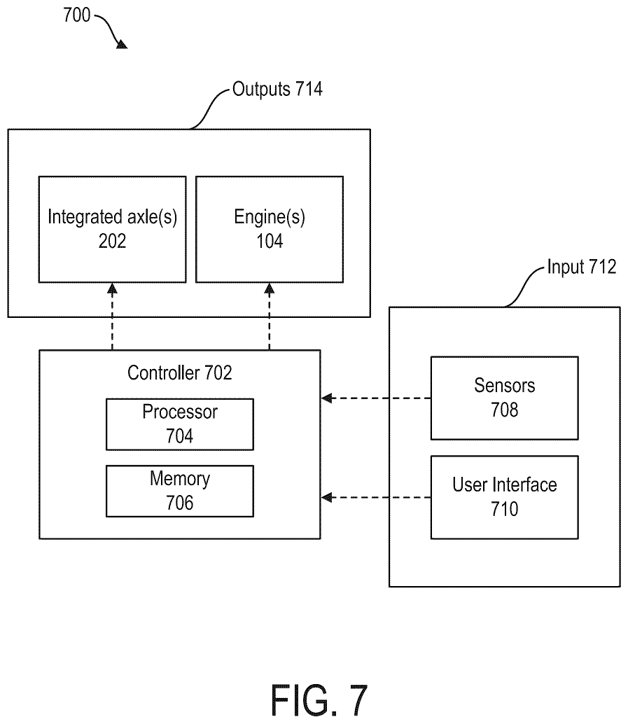

FIG. 7 shows an example of a control system 700 for the multi-mode hybrid vehicle system 200 as disclosed herein. The control system 700 includes a controller (multi-axle system controller) 702 which receives inputs 712 and controls the outputs 714. The controller 702 includes a processor 704 and a memory unit 706. The processor may be a microprocessor, a microcontroller, or any other suitable types of processing device or controller as known in the art. The controller 702 controls the operation of the integrated axle(s) 202 and engines 104 over communication lines, for example. It should be understood, however, that communication between controller and the integrated axle(s) and engine(s) may alternatively, or in addition, be performed wirelessly.

It should be understood that, in some embodiments, the controller 702 may form a portion of a processing subsystem including one or more computing devices having non-transient computer readable storage media 706, processors or processing circuits 704, and communication hardware. The controller 702 may be a single device or a distributed device, and the functions of the controller may be performed by hardware and/or by processing instructions stored on non-transient machine-readable storage media 706. Example processors 704 include an application specific integrated circuit (ASIC), a field programmable gate array (FPGA), a digital signal processor (DSP), and a microprocessor including firmware. Example non-transient computer readable storage media 706 includes random access memory (RAM), read only memory (ROM), flash memory, hard disk storage, electronically erasable and programmable ROM (EEPROM), electronically programmable ROM (EPROM), magnetic disk storage, and any other medium which can be used to carry or store processing instructions and data structures and which can be accessed by a general purpose or special purpose computer or other processing device.

Certain operations of the controller 702 described herein include operations to interpret and/or to determine one or more parameters. The parameters may be inputs 712 which may be information or data received from sensors 708 and/or user interface 710, among other means of providing inputs. The sensors may be any suitable sensor that can measure any change or increase in the load of the vehicle or the load applied on the vehicle. The sensors 708 may include, but are not limited to, weight sensors which detect the physical weight of the vehicle and/or its cargo, gyroscopes which detect the incline or decline in which the vehicle may be traveling, and altimeters which detect the altitude or change in altitude as the vehicle travels, among others.

Interpreting or determining, as utilized herein, includes receiving sensor values by any method known in the art, including at least receiving values over communication lines, from a datalink, network communication or input device, receiving an electronic signal (e.g. a voltage, frequency, current, or pulse-width-modulation signal) indicative of the value, such as the current and expected loads of a vehicle as well as user's preference or whether the rear axles are approaching or reaching their performance limit, for example, as further explained herein, receiving a computer generated parameter indicative of the value, reading the value from a memory location on a non-transient machine readable storage medium, receiving the value as a run-time parameter by any means known in the art, and/or by receiving a value by which the interpreted parameter can be calculated, and/or by referencing a default value that is interpreted to be the parameter value.

The above-described embodiments of the technology described herein can be implemented in any of numerous ways. For example, the embodiments may be implemented using hardware, software or a combination thereof. When implemented in software, the software code (or software algorithm) can be executed on any suitable processor 704 or collection of processors, whether provided in a single computing device or distributed among multiple computing devices. Such processors 704 may be implemented as integrated circuits, with one or more processors in an integrated circuit component, including commercially available integrated circuit components known in the art by names such as CPU chips, GPU chips, microprocessor, microcontroller, or co-processor. Alternatively, a processor 704 may be implemented in custom circuitry, such as an ASIC, or semicustom circuitry resulting from configuring a programmable logic device. As yet a further alternative, a processor may be a portion of a larger circuit or semiconductor device, whether commercially available, semi-custom or custom. As a specific example, some commercially available microprocessors have multiple cores such that one or a subset of those cores may constitute a processor. Though, a processor 704 may be implemented using circuitry in any suitable format.

Further, it should be appreciated that a computing device may be embodied in any of several forms, such as a rack-mounted computer, a desktop computer, a laptop computer, or a tablet computer. Additionally, a computing device may be embedded in a device not generally regarded as a computing device but with suitable processing capabilities, including a Personal Digital Assistant (PDA), a smart phone or any other suitable portable or fixed electronic device.

Also, a computing device may have one or more input and output devices. These devices can be used, among other things, to present the user interface 710 (which may be an output device as well as an input device). Examples of output devices that can be used to provide a user interface 710 include printers or display screens for visual presentation of output 714 and speakers or other sound generating devices for audible presentation of output 714. Examples of input devices that can be used for a user interface 710 include keyboards, and pointing devices, such as mice, touch pads, and digitizing tablets. As another example, a computing device may receive input information 712 through speech recognition or in other audible format.

Such computing devices may be interconnected by one or more networks in any suitable form, including as a local area network, a controller area network, or a wide area network, such as an enterprise network or the Internet. Such networks may be based on any suitable technology and may operate according to any suitable protocol and may include wireless networks, wired networks or fiber optic networks.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the disclosed embodiments may be embodied as a computer readable storage medium 706 (or multiple computer readable media) (e.g., a computer memory, one or more floppy discs, compact discs (CD), optical discs, digital video disks (DVD), magnetic tapes, flash memories, circuit configurations in Field Programmable Gate Arrays or other semiconductor devices, or other tangible computer storage medium) encoded with one or more programs that, when executed on one or more computers or other processors, perform methods that implement the various embodiments of the disclosure discussed herein. As is apparent from the foregoing examples, a computer readable storage medium 706 may retain information for a sufficient time to provide computer-executable instructions in a non-transitory form. Such a computer readable storage medium or media 706 can be transportable, such that the program or programs stored thereon can be loaded onto one or more different computers or other processors 704 to implement various aspects of the present disclosure as discussed above. As used herein, the term “computer-readable storage medium” encompasses only a non-transitory computer-readable medium that can be considered to be a manufacture (i.e., article of manufacture) or a machine. Alternatively, or additionally, the disclosure may be embodied as a computer readable medium other than a computer-readable storage medium, such as a propagating signal.

The terms “program” or “software” are used herein in a generic sense to refer to any type of computer code or set of computer-executable instructions that can be employed to program a computing device or other processor to implement various aspects of the present disclosure as discussed above. Additionally, it should be appreciated that according to one aspect of the disclosure, one or more computer programs that when executed perform methods of the present disclosure need not reside on a single computer or processor but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

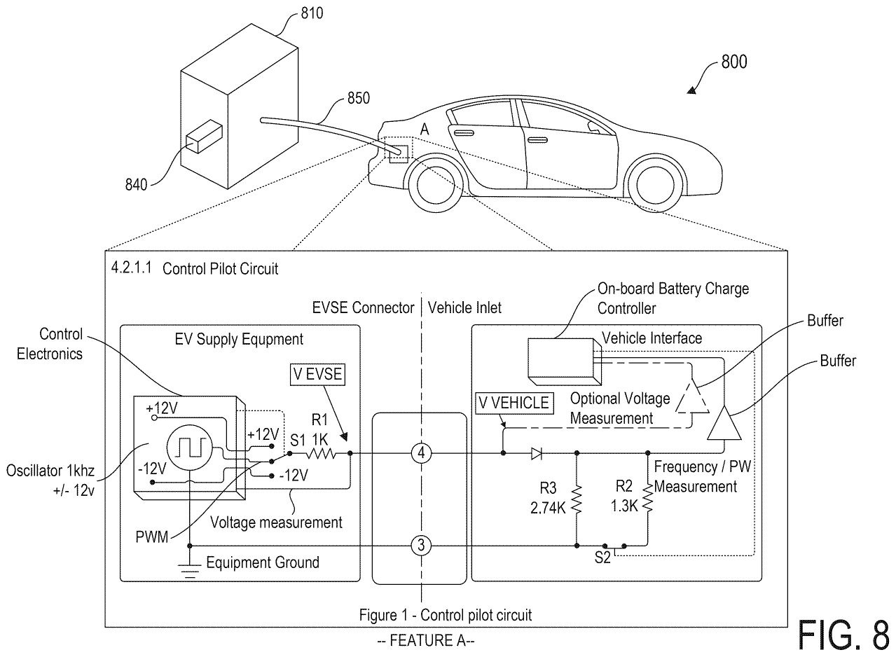

FIGS. 8-10 show various components and systems that implement principles of the present disclosure. Each of these figures will be discussed in detail below, beginning with environmental considerations for implementation.

The present disclosure relates to electrified vehicle technologies such as charging systems, charge control units (CCUs), Electric Vehicle Communication Controllers (EVCCs), and System Control Modules (SCMs). This disclosure applies to alternating current (AC), (DC), and battery pack transfer (BPT) charging. It provides a simple solution to unlock the chargeplug safely when there is a communication anomaly (e.g., loss) between multiple scenarios. For instance, those scenarios include communication loss between CCU and SCM, CCU and electric vehicle service equipment (EVSE), and/or CCU & EVSE (PLC Comms) and CCU & SCM.

Example implementations disclosed herein consider a CP (Control Pilot) state by the CCU when it encounters communication loss with SCM. For AC charging, these implementations consider the CP state transitioning to State B to unlock the plug. For DC charging & BPT, example implementations consider the CP state transitioning to State B and a timer can be enabled. This timer can be either a set or calibrated delayed timer in examples. The timer on when to unlock the plug can be calibratable such that after the timer expires, the CCU will unlock the chargeplug. This configuration eliminates a need for user intervention and/or manually unlocking the plug using the provision on top of the plug motor assembly. For instance, implementations disclosed herein can be characterized as autonomously unlockable or similar because where the chargeplug is unlocked in the aforementioned scenarios by checking the control pilot status and optionally using a time to unlock the plug.

Chargeplugs typically include several components, including a plug body, electrical contacts, and a locking mechanism. The plug body is designed to fit into the charging port on the vehicle, while the electrical contacts are responsible for transferring electric power from the charging station to the vehicle's battery system. The locking mechanism is designed to secure the chargeplug in place while the vehicle is charging, ensuring that the plug remains securely connected to the vehicle throughout the charging process.

One of the key features of chargeplugs in electrified vehicles is their ability to support different charging speeds and power levels. This is useful because different vehicles have different battery capacities and charging requirements, and the charging speed and power level will need to be adjusted accordingly. Chargeplugs are designed to support a range of charging speeds and power levels, enabling them to be used with a variety of different electrified vehicles.

Overall, chargeplugs in electrified vehicles are a useful component for the efficient and effective charging of these vehicles. These chargeplugs are designed to enable a connection between the vehicle and a power source, and they are responsible for transferring electric power from the charging station to the vehicle's battery system. With their ability to support different charging speeds and power levels, chargeplugs are an essential component for the widespread adoption of electrified vehicles.

The present disclosure relates generally to charging systems, and more specifically to charging systems that utilize different charging modes, such as alternating current (AC), direct current (DC), and BPT charging modes. The disclosure is particularly useful for electric vehicles, where the charging system plays a useful role in the overall performance and efficiency of the vehicle.

Currently, most electric vehicles are designed to be charged using AC or DC charging modes. AC charging is typically slower than DC charging, but it is more widely available and can be performed using a standard electric outlet. DC charging, on the other hand, is faster and more efficient, but it requires specialized charging equipment that is not as widely available as AC charging equipment.

The present disclosure improves upon existing charging systems by introducing a third charging mode, BPT charging, which allows for the transfer of energy directly from one battery pack to another. This mode of charging is particularly useful in situations where a vehicle is low on battery power and needs to be recharged quickly. By transferring energy directly from one battery pack to another, BPT charging can significantly reduce the amount of time required to recharge a vehicle.

In addition to the introduction of BPT charging, the present disclosure also includes a control system that allows for seamless switching between different charging modes. This control system is designed to optimize the charging process by selecting the most efficient charging mode based on factors such as the current battery level, the available charging equipment, and the desired charging time. By providing a more efficient and flexible charging system, the present disclosure can help to improve the overall performance and reliability of electric vehicles.

The present disclosure relates to electric vehicles and more particularly to a system and method for controlling pilot state transitioning in electric vehicles.

Electric vehicles are becoming increasingly popular due to their environmental friendliness and low operating costs. One of the challenges faced by electric vehicle manufacturers is the efficient management of the vehicle's power supply. A key component of this management is the pilot state, which is responsible for controlling the charging and discharging of the vehicle's battery. The pilot state is typically controlled by a dedicated microprocessor that monitors the state of the battery and adjusts the charging and discharging accordingly.

The present disclosure provides a system and method for controlling pilot state transitioning in electric vehicles. The system includes a controller that is responsible for managing the pilot state and transitioning between different states based on the state of the battery and the vehicle's power requirements. The controller is configured to receive input from various sensors and other components of the vehicle, such as the battery management system and the vehicle's power management system.

In operation, the controller monitors the state of the battery and the vehicle's power requirements and adjusts the pilot state accordingly. The controller is configured to transition between different states, such as charging, discharging, and idle, based on the state of the battery and the vehicle's power requirements. The system is designed to be highly efficient and to minimize energy waste, while also ensuring that the battery is charged and discharged in a safe and controlled manner. Overall, the system provides an effective and reliable solution for managing the pilot state in electric vehicles.

Control pilot signals are used in electrical circuits to communicate information between different devices. The control pilot circuit is a type of circuit that uses these signals to control the behavior of the devices connected to it. The signals are sent through wires and are interpreted by the devices to perform specific actions.

The control pilot signals work by sending a series of electrical impulses through the circuit. These impulses are interpreted by the devices connected to the circuit, which then perform specific actions based on the signals received. For example, a control pilot signal might tell a device to turn on or off, or to adjust its settings. The signals are carefully designed to ensure that they are reliable and accurate, and that they can be interpreted by a wide range of different devices. Overall, control pilot signals are a useful part of many electrical circuits, and are used to ensure that devices work together smoothly and efficiently.

EV charging standards are vital for ensuring compatibility and efficiency across the charging landscape. The SAE J1772 standard, widely used in North America, serves as the foundation for Level 2 AC charging, accommodating a variety of electric vehicles with its safe and versatile connector. Complementing J1772, the Combined Charging System (CCS) incorporates DC fast charging capabilities, allowing for much quicker recharge times and is increasingly adopted by many manufacturers. CHAdeMO, primarily utilized by Japanese automakers, is another prominent standard focused on DC fast charging, offering rapid charging solutions, though its usage is declining as CCS gains traction. TESLA™ has its proprietary charging system featuring Superchargers, which are designed specifically for TESLA™ vehicles but also support some non-TESLA™ models through adapters. In Europe, the Type 2 connector is commonly employed, supporting both AC and DC charging to meet diverse needs. Emerging technologies such as wireless charging and ultra-fast charging systems, like those being developed under the Hypercharger initiative, aim to enhance the charging experience further by enabling contactless charging and significantly reducing charging times. Additionally, the Open Charge Point Protocol (OCPP) is becoming increasingly useful for interoperability between different charging networks and management systems. As the EV market evolves, these standards and emerging technologies are useful for facilitating a seamless and efficient charging ecosystem.

Certain embodiments of the present invention are directed to the charging of an electric autonomous vehicle that is itself guided to a charging station via certain pavement markings. As illustrated in the figures, e.g. FIG. 6, the charging port 17 will typically be the charging outlet on the vehicle that will receive a connector that couples to power. In a home configuration, the receptacle can be provided with a connection to the power grid of the home. The receptacle is then connected to the charging port 17 of the vehicle when charging of the vehicles main battery 14 is desired. To guide the AV to charging stations or kiosks, several embodiments involve the use of pavement markings that permit unprecedented sensor feedback such that adverse weather conditions do not pose the problems presently experienced by self-driving systems presently employed. Having pavement markings that incorporate, for example, magnetic or RFID aspects that can be detected by sensors located in or on a vehicle offers the desired redundancy required to ensure a safer and more robust system that facilitates self-driving and steering mechanisms and systems for autonomous electric vehicles such that they can be efficiently charged prior to their batteries being fully drained of power.

Obtaining charge for an AV may include plugging the vehicle into a charging receptacle so as to charge the native battery of the vehicle, which can be done robotically or by the occupier of the AV when at the charging station. In certain embodiments, obtaining charge to an AV can also include refilling on volt bars to replenish volt bars that have been used during the vehicle usage. In other embodiments, charge can be transferred to the AV vehicle wirelessly (e.g., without plugging in an outlet or receptacle). Examples can include a transfer surface that the vehicle parks over, and the charge can be transferred wirelessly to the vehicle via conductors on the underside of the vehicle. The vehicle can simply park in the slot and once payment is made, the charge can start to flow capacitively or wirelessly to the electric vehicle. Directing the AV to the electric charge kiosks can involve the use of the pavement markers as more fully described herein that involve RFID and/or magnetic aspects that can be sensed by the AV and therefore properly positioned to obtain a charge, and then exit the charging kiosk after receiving a full charge of deleted batteries.

It should be understood that in preferred embodiments, charging of the AV is performed in accordance with an “EV Charging Standard” defined generally by standards set forth as follows A-E, and incorporated herein by this reference:
A. Combined Charging System 1.0 Specification—CCS 1.0 (Version 1.2.7 (2017 Jan. 26));
B. Bharat EV Charging Standards AIS-138 (Part 1 and Part 2);
C. CHAdeMO published as IEEE Standard 2030.1.1™-2015;
D. The GB EV Charging Standards including GB 18487.1-2015, GB 20234.1-2015, GB 20234.2-2015, GB 20234.3-2015, GB 27930-2015, Q/GDW 397-2009, Q/GDW 398-2009, Q/GDW 399-2009, Q/GDW 400-2009 and GB/T 18384.3-2015; or
E. SAE J1772, IEC 62196-1:2014, IEC 62196-2:2011, IEC 62196-3:2014, IEC 60309, IEC 61851-1 Ed 2.0:2010, IEC 61851-1 Ed 3.0:2017, IEC 61851-21:2014, IEC 61851-21:2017, IEC 61851-22, IEC 61851-23:2014, IEC 61851-24:2014, ISO 15118-1:2013, ISO 15118-2:2014, ISO 15118-3:2015, DIN Spec 70121:2014-12, SAE J2847/2, ISO 6469-3, and ISO 17409:2013-09.

The foregoing standards include all standards referenced to be used in their implementation whether implemented independently or in combination. For example, with respect to the standard in “E”—SAE J1772,—The SAE J-1772 committee develops connector standards for plug-in vehicles in the US. The J-1772 Standard comprises three levels . . . IEC 61851 promotes different charging levels analogous to SAE J1772.

IEC 62196-1:2014—the IEC International Standard 62196-1 (2014) defines the general requirements that apply to plugs, socket-outlets, vehicle connectors, vehicle inlets and cable assemblies for electric vehicles, incorporating control solutions and having a rated voltage. IEC 62196-2:2011, IEC 62196-3:2014, IEC 60309,—plug/socket type IEC 60309; IEC 61851-1 Ed 2.0. Standards like ISO/IEC 15118 and IEC 61851-1 are developed to ensure base level interoperability of front-end communication and signaling processes for smart charging between electric vehicles and charge spots.

2010, IEC 61851-1 Ed 3.0:2017, IEC 61851-21:2014, IEC 61851-21:2017, IEC 61851-22, IEC 61851-23:2014, IEC 61851-24:2014, ISO 15118-1. The ISO 15118 standard shows the potential of this future-proof charging communication protocol used for integrating electric vehicles (EVs) into the smart grid.

2013, ISO 15118-2:2014, ISO 15118-3:2015, DIN Spec 70121. DIN SPEC 70121 describes the Communication for DC Charging between Charging Station and an Electric Vehicle. 2014 December, SAE J2847/2. The SAE J2847/2 standard establishes the application layer specifications and requirements for DC charging.

ISO 6469-3, ISO 6469-3:2001—Electric road vehicles—Safety specifications—Protection of persons against electric hazards 90.92 ISO 6469-3.

ISO 17409:2013-09, in accordance with new standards for DC-charging (ISO 17409).

In one embodiment, a method is set forth that enables the charging of an electric autonomous vehicle employing rechargeable batteries. The electric AV vehicle has at least one receptacle slot integrated in the AV that provides for a connection to a power source for providing power to an electric motor of the electric AV vehicle. When the AV vehicle's battery charge is low, the vehicle employs a computer-implemented method to locate a kiosk or charging station. Such kiosks have receptacle slots for one or more of holding, charging and/or dispensing batteries. In preferred embodiments, the AV is charged at the kiosk via the computer-implemented method that involves a request for a geographic location of at least one kiosk location proximate to the geographic location of the A.

Discussion hereinafter now relies on SAE J1772 for conciseness, but it should be understood that this is one example of many examples disclosed herein. One skilled in the art will appreciate that the disclosure can be adapted to fit other standards without departing from the scope of this disclosure.

The CP mode in the SAE J1772 standard is a crucial component for communication between electric vehicles (EVs) and electric vehicle supply equipment (EVSE). It provides a mechanism for ensuring safe, efficient, and standardized charging. Here's a detailed technical explanation of how Control Pilot mode operates:

As an overview, the CP mode is a useful component in EV charging systems, facilitating communication between the EV and the EVSE. Its primary functions include enabling the EV to request the appropriate charging current and ensuring that the EVSE can provide the correct amount of current. Additionally, the CP mode incorporates safety features to detect faults, verify connections, and prevent unsafe charging conditions. The CP signal operates at a frequency of 1 kHz, with voltage levels typically ranging between 0 and 12 V. Depending on the charging mode, the signal can be either AC or DC. The CP signal employs Pulse-Width Modulation (PWM) to encode information, with the duty cycle of the PWM signal varying to represent different current levels and other status information.

The CP mode encompasses several operational modes. Mode 1 represents a basic, non-communicative charging approach where the CP pin is not actively used for communication but rather relies on a fixed voltage to provide power. Mode 2 introduces a basic communication level, where the CP signal detects the presence of the vehicle through slight variations in the duty cycle, indicating that the vehicle is connected. Mode 3, the most advanced, supports full communication using the CP signal, allowing detailed control and information exchange during the charging process.

In Mode 3, the EV and EVSE use the duty cycle of the 1 kHz PWM signal to convey information about the maximum current the EVSE can provide. For instance, a 10% duty cycle may indicate a maximum current of 10 A, a 50% duty cycle might represent 16 A, and a 100% duty cycle could denote 32 A. The EV uses the CP signal to request a specific charging current by adjusting the duty cycle, and the EVSE responds by adjusting its output to match the requested current, provided it can safely do so.

Presence detection in CP mode involves measuring the impedance between the CP pin and ground to ensure proper vehicle connection. A specific impedance range confirms readiness for charging, and if the impedance does not match expected values, the EVSE may withhold charging. Safety mechanisms include an interlock feature to secure the connector before charging begins and fault detection capabilities to monitor for issues such as short circuits or ground faults, with the EVSE halting charging and signaling an error if a fault is detected.

The communication process starts when the EV is plugged into the EVSE, initiating the CP signal at a default 1 kHz frequency and a default readiness signal from the EVSE. The EV modulates the CP signal's duty cycle to request a specific current level, and the EVSE adjusts its output accordingly, confirming the setup. Upon completion of negotiation and safety checks, the charging process commences, with the EVSE continuing to monitor the CP signal for any changes or faults.

Voltage levels of the CP signal range between 0 and 12 V, encoding information about charging capabilities. The impedance between the CP pin and ground must fall within a specified range to indicate a valid connection, with deviations potentially signaling problems. In summary, the SAE J1772 Control Pilot mode is essential for managing EV and EVSE communication, using pulse-width modulation to encode current capacity information and ensuring safe, effective, and standardized charging across various vehicles and charging stations.

In SAE J1772 Control Pilot mode, the CP signal plays a central role in managing communication between the EV and the EVSE. It uses pulse-width modulation to encode information about the maximum current capacity and to facilitate safe and effective charging. By ensuring proper signaling, detecting faults, and negotiating current levels, the CP mode enables standardized and reliable EV charging across different vehicles and charging stations.

In SAE J1772, the CP signal operates to manage the charging process between an EV and an EVSE. Understanding the differences between the various base states of the CP signal is crucial for ensuring proper communication and safe operation during EV charging. Here's a detailed technical explanation of these base states:

The following discussion pertains to base states of the CP signal. The CP signal in the SAE J1772 standard operates through various base states, each characterized by distinct voltage levels and pulse-width modulation (PWM) duty cycles to convey different information about the EV and the EVSE.

In the “Not Connected” state, the CP signal exhibits a maximum voltage of approximately 12 V, with no PWM signal present due to the open circuit. This state indicates that no vehicle is plugged in or the connector is not properly engaged, prompting the EVSE to refrain from initiating charging.

When the vehicle is detected, known as the “Vehicle Detection” state, the CP signal's voltage drops to a lower level, typically between 6 and 9 V, and a continuous PWM signal at 1 kHz with a duty cycle varying around 20-30% is present. This state signifies that a vehicle is connected, allowing the EVSE to perform initial safety checks without specific charging parameters.

The “Idle State” features a constant voltage within a range of 6-12 V but with minimal modulation. The PWM signal is steady with a relatively low duty cycle, around 10-20%. This state denotes that the vehicle is connected but charging has not yet commenced, used primarily for preliminary checks and to prepare for negotiation.

During the “Charging State,” the CP signal maintains a steady but reduced voltage, typically between 6 and 9 V, and the PWM duty cycle varies from 10% to 100%, reflecting the requested current levels. This state indicates active charging where the EVSE and EV are negotiating and managing the charging process, with the duty cycle dictating the current adjustments.

In the “Fault State,” the CP signal's voltage may drop to a lower level or fluctuate erratically, and the PWM signal might become irregular or cease entirely. This state signals a fault condition, such as a short circuit or ground fault, prompting the EVSE to halt charging to ensure system safety.

The “Standby or Power-Off State” is characterized by a significantly reduced or zero voltage level, with minimal or absent PWM signal. This state indicates that the EVSE is inactive or not supplying power, even though the EV is plugged in.

Understanding these base states—ranging from detection and idle preparation to active charging, fault indication, and power-off—is crucial for diagnosing issues, ensuring proper operation, and maintaining safety in EV charging systems. The SAE J1772 standard's signaling protocols are essential for negotiating charging parameters, conducting safety checks, and managing the overall charging process effectively.

The following is a technical explanation of signaling protocols in SAE J1772. The CP signal plays a crucial role in the communication between an EV and the EVSE, facilitating the negotiation of charging parameters and ensuring safe operation. Operating at a frequency of 1 kHz, the CP signal's duty cycle varies to encode different types of information, with its voltage levels ranging from 0 to 12 V, depending on the mode of operation.

There are several signaling modes for the CP signal. In Mode 1, basic charging occurs without detailed communication, characterized by a continuous 1 kHz waveform with a fixed duty cycle and no significant data variations. Mode 2 introduces simple communication, where slight variations in the CP signal's duty cycle indicate the presence of the vehicle, allowing the EVSE to detect whether the EV is connected. Mode 3, the most advanced, supports detailed communication with full control and safety features. Here, the CP signal uses pulse-width modulation (PWM) to encode information about the maximum charging current the EVSE can provide. The EV communicates its current requirements through the CP signal, prompting the EVSE to adjust its output accordingly.

In Mode 3, the EV requests a specific current level by varying the duty cycle of the PWM signal. For instance, a 0% duty cycle might indicate a maximum current of 10 A, a 50% duty cycle could correspond to 16 A, and a 100% duty cycle may represent 32 A. The EVSE responds by adjusting its output current based on the received duty cycle.

The CP signal also plays a key role in presence detection and safety. Impedance measurement helps the EVSE verify that a vehicle is properly connected. The connector is mechanically locked to prevent accidental disconnection during charging, and the CP signal ensures the connector is engaged before charging begins. Additionally, the CP signal aids in detecting faults such as short circuits or ground faults, with the EVSE monitoring the signal and halting charging if unsafe conditions are detected.

Fault conditions, including short circuits or ground faults, prompt the EVSE to stop supplying power and alert the user through status indicators. Communication failures or inconsistencies in the CP signal may also lead to the EVSE halting charging and signaling a fault condition.

Furthermore, the CP pin measures resistance between the CP and Ground to identify the EV's characteristics and confirm a proper connection. This resistance measurement helps the EVSE determine the EV's charging capability and adjust its output for optimal safety and efficiency. In summary, the SAE J1772 signaling protocols, utilizing the Control Pilot signal, are essential for safe and efficient EV charging, enabling reliable communication, proper connection, and fault detection across various vehicles and charging stations.

Assuming that the communication loss between the SCM and CCU occurs during the charging process (power delivery), the CCU shall open the S2 switch which indicates the EVSE to end charging. Depending on the mode of charging (AC vs DC), the CCU will wait until the CP state transitions to State B to unlock the plug (for AC charging). For DC charging, the CCU shall open the S2 switch and wait till the CP state transitions to State B, once transitioned the CCU will enable an internal timer (calibratable) and wait for it to expire before unlocking the chargeplug safely.

In the SAE J1772 standard for EV charging, the S2 switch is a useful component used to ensure safety and proper operation of the charging system. The S2 switch is part of the control and safety mechanisms involved in the communication between the EV and the EVSE. Here's a detailed explanation of the S2 switch and its role:

Details of the S2 Switch in Electric Vehicle Charging Systems will now be discussed. The S2 switch is a useful component in EV charging systems, specifically designed to enhance safety and operational reliability during the charging process. This switch serves multiple functions, primarily acting as a safety interlock to ensure that the connector is properly engaged and remains securely connected throughout charging. By preventing accidental disconnections, the S2 switch plays a vital role in safeguarding both the vehicle and the EVSE. Furthermore, the S2 switch aids the EVSE in detecting whether the connector is correctly inserted into the EV, thereby determining if the charging process can safely commence.

Positioned within the connector or charging plug, the S2 switch is a mechanical device that activates upon full insertion of the connector into the vehicle's charging receptacle. When the connector is properly engaged, the S2 switch closes, completing an electrical circuit that signals the EVSE that the connector is securely connected, thus allowing the charging process to initiate. In the context of the SAE J1772 connector pinout, the S2 switch is typically associated with the CP and Proximity Detection (PD) pins. The S2 switch may also be integrated into the Proximity Detection system, which confirms not only the presence of the vehicle but also the correct alignment and locking of the plug.

The S2 switch performs a crucial role during the pre-charging verification process. Before charging begins, the EVSE assesses the state of the S2 switch; if the switch indicates improper engagement, the EVSE is programmed to withhold charging, thereby ensuring user safety. Additionally, the S2 switch often operates in conjunction with the mechanical locking mechanism of the connector, reinforcing the secure connection and reducing the risk of accidental disconnections that could interrupt charging and pose safety hazards.

Safety protocols are embedded in the functionality of the S2 switch. In scenarios where the switch detects an issue—such as an improper connection or disconnection—the EVSE is designed to halt the charging process to avert unsafe conditions. If the S2 switch fails to operate correctly, the EVSE may signal an error or fault condition, alerting the user to inspect the connection and address potential issues with the connector or plug.

The S2 switch also interacts with the CP signal to verify the integrity of the connection. The CP signal monitors the status of the S2 switch as part of a comprehensive system check prior to initiating the charging process. Utilizing the data from the S2 switch, the EVSE performs essential safety checks, ensuring that the charging process proceeds only when all necessary conditions are met.

In summary, the S2 switch, as defined in the SAE J1772 standard, is instrumental in ensuring the safety and proper operation of the EV charging system. It functions as a safety interlock that confirms secure connector engagement before allowing the charging process to begin. By integrating with the Proximity Detection system and interacting with the Control Pilot signal, the S2 switch enhances the reliability and safety of interactions between the EV and the EVSE.

In the SAE J1772 standard for electric vehicle charging, various states define the interaction between the EVSE and the electric vehicle. State A represents the initial condition where the EVSE is not connected to any vehicle, and no communication occurs. State B1 occurs when the EVSE detects the presence of a vehicle, initiating communication but not yet starting the charging process. In State B2, the vehicle's connector is physically inserted into the EVSE, prompting the system to verify the connection and check the integrity of the interface.

In the SAE J1772 standard for electric vehicle charging, various states define the interaction between the EVSE and the electric vehicle. State A represents the initial condition where the EVSE is not connected to any vehicle, and no communication occurs. State B1 occurs when the EVSE detects the presence of a vehicle, initiating communication but not yet starting the charging process. In State B2, the vehicle's connector is physically inserted into the EVSE, prompting the system to verify the connection and check the integrity of the interface.

Moving to State C, the EVSE conducts essential safety checks and confirms that the connector is securely engaged, often involving a pre-charging handshake to establish communication with the vehicle. Once all checks are complete, the system transitions to State D, where charging actively takes place, with the EVSE supplying power to the vehicle while continuously monitoring the connection for safety. After the charging session is complete, the system enters State E, during which the EVSE stops supplying power and prepares for disconnection, while final communications with the vehicle may continue. Finally, State F indicates that the connector has been removed from the vehicle, signaling a return to the initial state where the EVSE is ready for a new charging session, with no active charging occurring. These states ensure safe and efficient operation throughout the EV charging process.

Table 1 below shows definitions of vehicle and/or EVSE states as defined by SAE J1772.

TABLE 1
Definition of vehicle/EVSE states.

| | V EVSE | V Vehicle | |
|---|---|---|---|
| State | (vdc | (vdc | |
| Designation | Nominal)⁽⁵⁾ | Nominal)⁽⁵⁾ | Description of Vehicle/EVSE State |
| State A | 12.0⁽¹⁾ | 0⁽¹⁾ | Vehicle not connected |
| State B1 | 9.0⁽¹⁾ | 9.0⁽¹⁾ | Vehicle connected/not ready to accept energy |
| | | | EVSE not ready to supply energy. |
| State B2 | 9.0⁽²⁾⁽³⁾ | 9.0⁽²⁾⁽³⁾ | Vehicle connected/not ready to accept energy |
| | | | EVSE capable to supply energy |
| State C | 6.0⁽²⁾ | 6.0⁽²⁾ | Vehicle connected/ready to accept energy/indoor charging area ventilation |
| | | | not required |
| | | | EVSE capable to supply energy |
| State D | 3.0⁽²⁾ | 3.0⁽²⁾ | Vehicle connected/ready to accept energy/indoor charging area ventilation |
| | | | required |
| | | | EVSE capable to supply energy |
| State E⁽⁴⁾ | 0 | 0 | EVSE disconnected from vehicle/EVSE disconnected from utility, EVSE |
| | | | loss of utility power of control pilot short to control pilot reference |
| State F | −12.0⁽¹⁾⁽⁶⁾ | −12.0⁽¹⁾⁽⁶⁾ | Other EVSE problem. |

⁽¹⁾Static voltage.

FIG. 8 is an isometric view of a power source with a battery management system that is coupled to an electric or hybrid vehicle, according to an exemplary embodiment. In FIG. 8, the battery management system 840 is embodied within the power source 810. In this embodiment, the SCM provides data regarding one or more batteries of the vehicle 800 to the system 840 via a charging connection 850. Thus, the battery management system 840 (via a controller) regulates the amount of charge delivered to the battery at the power source 810 directly and not upon reception of the charge within the vehicle 800. The charging connection 850 may be any typical wired connector that enables the transfer of charge and data from the power source 810 (and battery management system 840) to the battery or batteries and vice versa. In another embodiment, the charging connection 850 may include any wireless connection that enables the transfer of charge and data, such as induction pads.

Feature A shows a close up of a control pilot circuit that is an interface between the Electric Vehicle Supply Equipment (EVSE) connector and the vehicle inlet, facilitating efficient communication during the charging process. The circuit employs a PWM signal, with resistor R1 connected to the EVSE and R2 to the vehicle inlet, creating a voltage divider that establishes the reference voltage for the system. Control electronics within the vehicle monitor this signal to determine the maximum current capacity and the charging mode. Resistor R3, located on the vehicle side, helps buffer the control pilot signal for accurate voltage measurements. The onboard battery charge controller uses these inputs to manage the charging process, ensuring safe operation by adjusting the current supplied based on real-time communication and monitoring for potential faults in the system.

With reference to FIG. 8, discussion now turns to describing the resistor and different states of the Control Pilot. In general, an assumption that can be made is that R1 is always present in the circuit on the EVSE Side and considered part of the EVSE circuit. Table 2 below provides information about the CP circuit in FIG. 8 in various situations.

TABLE 2
Control Pilot Circuit States in Operative Situations.

| | Resistor in | |
|---|---|---|
| | Circuit on | EVSE |
| Description of the situation | EV Side | State |
| During Active Charge Session without | R2 and R3 | State C |
| ventilation. In this Situation Charge | are in | |
| Permission is provided by the SCM which is | parallel | |
| used by the CCU to close the S2 switch. | | |
| During Active Charge Session without | Only R3 | State B2 |
| ventilation if there is a loss of communication | | |
| between the SCM and CCU. CCU would | | |
| open S2 switch and EVSE oscillator still ON. | | |
| EVSE ramps down current at a rate of | Only R3 | State B1 |
| 200 A/sec as per J1772 for emergency shut | | |
| down and oscillator turns off | | |
| CCU to wait for x amount of time and then | Only R3 | State B1 |
| unlock the charge gun. | | |

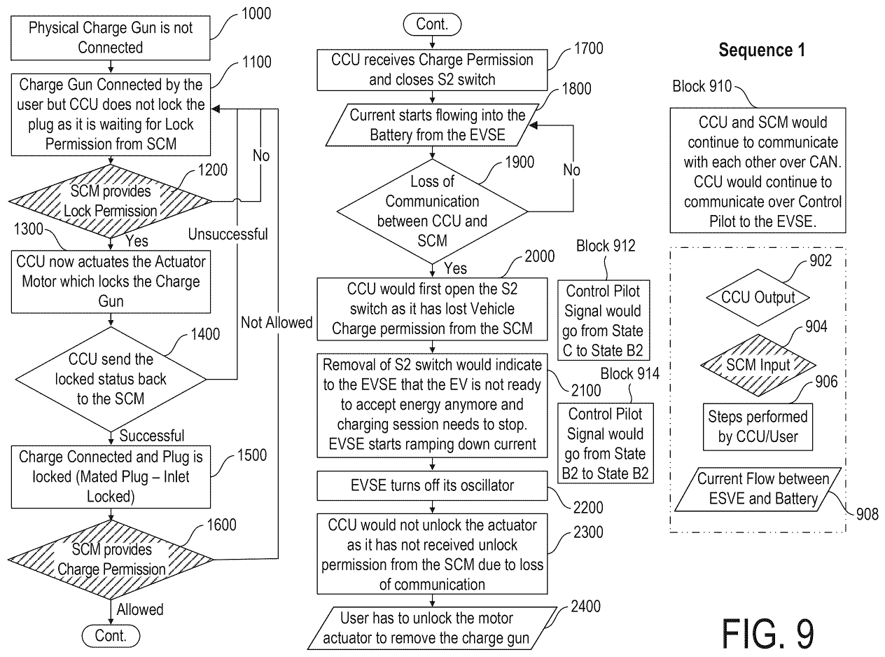

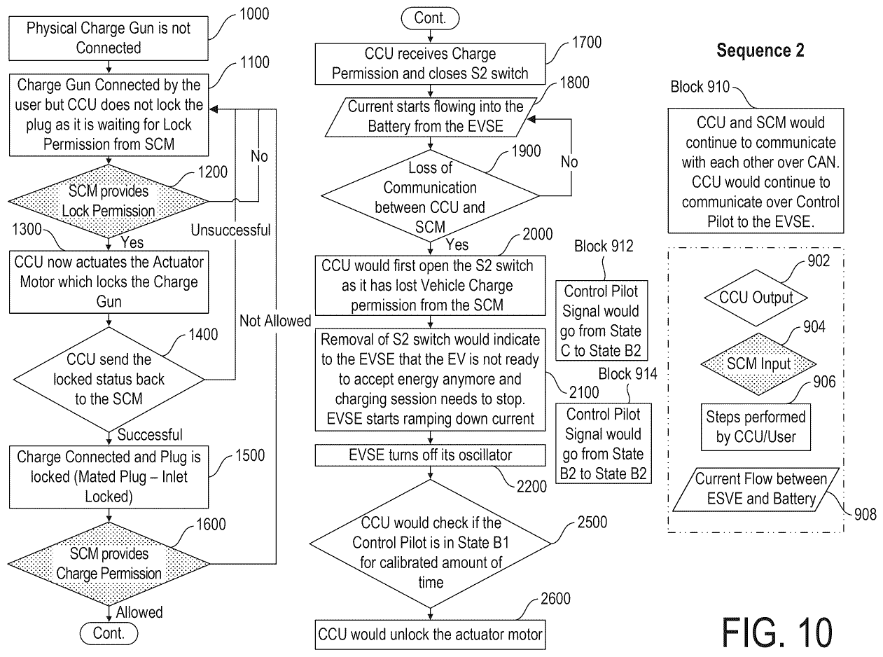

FIGS. 9 and 10 provide sequences for unlocking the chargeplug due to loss of communication. In each of the illustrated scenarios, variables include an Output from the CCU 902, Input from the SCM 904, Steps performed by the CCU/User 906, and Current Flow between EVSE and Battery 908.

For illustration purposes only, Sequence 1 in FIG. 9 shows scenarios where the CCU and the SCM continue to communicate with each other over CAN (Block 910). At an overview, the CCU continues to communicate over Control Pilot to the EVSE. Control Pilot Signal goes from State C to State B2 (Block 912). Additionally, the Control Pilot Signal goes from State B2 to State B1 (Block 914).

More specifically, Sequence 1 starts with the physical charge gun not connected (Step 1000). Then, the charge gun is connected by the user; however, the CCU does not lock the plug, for the CCU waits for Lock Permission from the SCM to lock (Step 1100). The CCU continues to check whether the SCM provides Lock Permission (Step 1200). If the SCM does not provide Lock Permission, the CCU continues to wait (Step 1100). Once the SCM provides Lock Permission, the CCU will then actuate the Actuator Motor which locks the charge gun (Step 1300). Then, the CCU attempts to send the locked status back to the SCM (Step 1400). If the send is unsuccessful, the CCU goes back to waiting for Lock Permission from the SCM (Step 1100). If the send is successful, however, the CCU locks the plug, and the charge is connected (Step 1500). Following Step 1500, the SCM attempts to provide Charge Permission (Step 1600). If Charge Permission is not allowed, the system returns to Step 1100. If the Charge Permission is allowed, the CCU receives the Charge Permission and closes the S2 switch (Step 1700), then the current starts to flow from the EVSE into the battery (Step 1800). Following Step 1800, the system checks if the CCU outputs an indication of a Loss of Communication between the CCU and SCM (Step 1900). If there is no Loss of Communication indication, current remains flowing into the battery from the EVSE (Step 1800). If there is Loss of Communication, the CCU first opens the S2 as it loses Vehicle Charge Permission from the SCM (Step 2000), the EVSE starts ramping down current because the removal of the S2 switch indicates to the EVSE that the EV is not ready to accept energy anymore and the charging session needs to stop (Step 2100), and finally the EVSE turns off its oscillator (Step 2200). After the EVSE turns off the oscillator (Step 2200), the CCU does not unlock the actuator, for the CCU has not received Unlock Permission from the SCM due to the Loss of Communication (Step 2300). As such, the User needs to unlock the motor actuator to remove the charge gun (Step 2400).

In addition, or in alternative, Sequence 2 in FIG. 10 shows scenarios where the CCU and the SCM—at an overview—continue to communicate with each other over CAN (Block 910). The CCU continues to communicate over Control Pilot to the EVSE. And distinctively, before unlocking the actuator motor, the CCU checks if the Control Pilot Signal is in State B1 for a calibrated amount of time.

More specifically, Sequence 2 begins the same as Sequence 1 from Steps 1000-2200. Following Steps 2000-2200, however, the CCU then checks if the Control Pilot is in State B1 for a calibrated amount of a time (Step 2500), then the CCU would unlock the actuator motor (Step 2600).

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

### Practical Implementations

In one general aspect, method may include receiving an indication of a compromised communication between a CCU of an EV and at least one of a system control module of the EV and EVSE that is connectible to the EV for a charging session of an Energy Storage System of the electrified vehicle. Method may also include unlocking the chargeplug from the electrified vehicle in response to receiving the indication. Other embodiments of this aspect include corresponding computer systems, apparatus, and computer programs recorded on one or more computer storage devices, each configured to perform the actions of the methods.

Implementations may include one or more of the following features. Method where the receiving the indication includes receiving the indication that corresponds to a control pilot signal. Method where the control pilot signal indicates a change in state designation to an autonomously unlockable state. Method where the autonomously unlockable state is one of State B1, State B2, and State C. Method where the autonomously unlockable state corresponds to a state of an arrangement of resistors in a control pilot circuit. Method where the arrangement of resistors includes a plurality of resistors. Method where the plurality of resistors includes an EV side resistor on an EV side of the control pilot circuit. Method where the plurality of resistors further includes an EVSE side resistor on an EVSE side of the control pilot circuit. Method where the plurality of resistors further includes a second EV side resistor at the EV side of the control pilot circuit. Method where the unlocking the chargeplug from the electrified vehicle in response to receiving the indication includes waiting a delay time before unlocking the chargeplug such that the chargeplug is able to be safely removed. Implementations of the described techniques may include hardware, a method or process, or a computer tangible medium.

In one general aspect, vehicle inlet may include A vehicle inlet of a control pilot circuit for an electrified vehicle. Other embodiments of this aspect include corresponding computer systems, apparatus, and computer programs recorded on one or more computer storage devices, each configured to perform the actions of the methods.

Implementations may include one or more of the following features. Vehicle inlet where the communication anomaly indicates that a Charge Control Unit has lost communication with at least one of the EVSE and a System Control Module. Vehicle inlet where the communication anomaly is indicated by a control pilot state. Vehicle inlet where the vehicle inlet responds to a transition in the control pilot state by actuating the switch. Vehicle inlet where the chargeplug autonomously enters the unlocked state after a delay time when the charge control unit has experienced the communication anomaly. Implementations of the described techniques may include hardware, a method or process, or a computer tangible medium.

In one general aspect, controller may include a controller for an energy storage system. Other embodiments of this aspect include corresponding computer systems, apparatus, and computer programs recorded on one or more computer storage devices, each configured to perform the actions of the methods.

Implementations may include one or more of the following features. Controller where the controller is configured to communicate with a resistor arrangement having a plurality of states, including an autonomously unlockable state and a locked state, the autonomously unlocked state corresponding to State B1, State B2, or State C. Controller where the one or more processors is further configured to implement a delay time before causing the connectible chargeplug to enter the autonomously unlockable state. Controller where the controller is integrated into an electrified vehicle. Controller where the controller is further configured to be in communication with a control pilot circuit, and where the indicator corresponds to a voltage at the control pilot circuit. Implementations of the described techniques may include hardware, a method or process, or a computer tangible medium.

### Guidance

The following section provides interpretive guidance for understanding and applying the principles described in this disclosure. It outlines key concepts related to embodiment flexibility, parameter variation, structural adaptability, and claim interpretation for methods for safe, autonomous unlocking of a chargeplug from an electrified vehicle during an active charge session. While this section sets forth representative principles by which one skilled in the art may interpret the scope and implementation of the disclosed systems, it is not exhaustive and should not be construed as limiting. Instead, it serves to ensure clear, adaptable, and contextually accurate understanding of the embodiments described herein, including their potential equivalents and extensions under applicable patent law.

The description provided is intended to accompany and clarify the figures and flow diagrams included in this disclosure, with the goal of instructing one skilled in the art in representative implementations of overcurrent protection, materials, estimation methods, and control strategies. Where terms such as “is,” “are,” or similar definitive language are used to describe elements in the figures, such usage should not be interpreted as limiting or exclusive. Instead, such terms reflect how features may be implemented or depicted in example embodiments. As will be apparent to those skilled in the art, the described configurations are illustrative only and do not preclude alternative structures, materials, or arrangements that accomplish comparable functions. The figures and description are thus to be understood as non-limiting examples among many possible implementations consistent with the broader principles disclosed herein.

It is well understood that methods that include one or more steps, the order listed is not a limitation of the claim unless there are explicit or implicit statements to the contrary in the specification or claim itself. It is also well settled that the illustrated methods are just some examples of many examples disclosed, and certain steps can be added or omitted without departing from the scope of this disclosure. Such steps can include incorporating devices, systems, or methods or components thereof as well as what is well understood, routine, and conventional in the art.

The connecting lines shown in the various figures contained herein are intended to represent exemplary functional relationships and/or physical couplings between the various elements. It should be noted that many alternative or additional functional relationships or physical connections can be present in a practical system. However, the benefits, advantages, solutions to problems, and any elements that can cause any benefit, advantage, or solution to occur or become more pronounced are not to be construed as useful, required, or essential features or elements. The scope is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone can be present in an embodiment, B alone can be present in an embodiment, C alone can be present in an embodiment, or that any combination of the elements A, B or C can be present in a single embodiment; for example, A and B, A and C, B and C, or A and B and C.

The embodiments and examples presented in the detailed description are intended to be illustrative and not exhaustive. Specific configurations are described for clarity, but they represent only a subset of possible implementations that may be developed based on the disclosure herein. Features of one embodiment may be combined with features of another, whether or not such combinations are explicitly described. Similarly, individual features may be omitted from certain implementations without departing from the scope of the claims. All such variations, substitutions, and adaptations apparent to a person of ordinary skill in the art are considered within the scope of this disclosure and its claims.

In the detailed description herein, references to “one embodiment,” “an embodiment,” “an example embodiment,” etc., indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art with the benefit of the present disclosure to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is to be construed under the provisions of 35 U.S.C. 112 (f), unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but can include other elements not expressly listed or inherent to such process, method, article, or apparatus.

While various embodiments of the disclosure have been shown and described, it is understood that these embodiments are not limited thereto. The embodiments may be changed, modified and further applied by those skilled in the art. Therefore, these embodiments are not limited to the detail shown and described previously, but also include all such changes and modifications.

Ranges provided in this disclosure should be interpreted to include both their stated endpoints and any intermediate values, unless explicitly indicated otherwise. Unless otherwise stated, a range or single value should be understood to include values that one of ordinary skill in the art would deem generally equivalent or sufficiently close for the intended function, including values that vary by plus or minus a reasonable percentage appropriate for the technical field. Phrases such as “generally within a range,” “approximately,” “about,” “substantially,” “roughly,” “sufficiently,” or similar qualifiers, when used with ranges or values, are intended to allow for practical engineering and manufacturing tolerances, measurement uncertainty, and performance margins without limiting the claims to absolute numerical boundaries. These terms do not narrow the scope of the claims to exact figures unless expressly stated otherwise. Where a single value or limit is disclosed without an explicit range, it should be interpreted as encompassing that value and all functionally equivalent values within such reasonable variation, consistent with the doctrine of equivalents.

Use of “or” in lists should be understood as inclusive unless the context clearly indicates otherwise, meaning that any one, any combination, or all listed elements may be encompassed. Phrases such as “at least one of A, B, and C” should be interpreted to mean any of A, B, or C individually, any combination thereof, or all of them together. The term “a portion” may refer to part or all of a given element, unless clearly indicated otherwise.

Terms such as “coupled,” “connected,” or “joined” encompass both direct and indirect relationships between elements, including mechanical, electrical, thermal, or fluidic connections, whether fixed, flexible, integrated, or modular. For example, components described as “thermally coupled” or “electrically connected” include arrangements with or without intervening interfaces, conductive paths, or insulating structures.

Where steps in a method are presented in a specific order, that order should not be construed as required unless explicitly stated. Method steps may be performed in different sequences, in parallel, combined, or omitted, depending on the desired implementation. Descriptions of method operations are provided for illustrative guidance and do not limit procedural flexibility except where explicitly recited in the claims.

The structures, materials, methods, and configurations described herein are intended to illustrate, not limit, the scope of the invention. All modifications, substitutions, equivalents, and functional alternatives that achieve the described objectives using different arrangements—whether now known or later developed—are intended to fall within the scope of the appended claims and are protected under applicable doctrines of patent law, including the doctrine of equivalents.

What is claimed is:

1. A method for safe, autonomous unlocking of a chargeplug from an electrified vehicle during an active charge session, the method comprising:
receiving an indication of a compromised communication between a charge control unit (CCU) of an electrified vehicle (EV) and at least one of a system control module of the EV and Electric Vehicle Supply Equipment (EVSE) that is connectible to the EV for a charging session of an Energy Storage System of the electrified vehicle; and
unlocking the chargeplug from the electrified vehicle in response to receiving the indication.

2. The method of claim 1, wherein the receiving the indication includes receiving the indication that corresponds to a control pilot signal.

3. The method of claim 2, wherein the control pilot signal indicates a change in state designation to an autonomously unlockable state.

4. The method of claim 3, wherein the autonomously unlockable state is one of State B1, State B2, and State C.

5. The method of claim 3, wherein the autonomously unlockable state corresponds to a state of an arrangement of resistors in a control pilot circuit.

6. The method of claim 5, wherein the arrangement of resistors includes a plurality of resistors.

7. The method of claim 6, wherein the plurality of resistors includes an EV side resistor on an EV side of the control pilot circuit.

8. The method of claim 7, wherein the plurality of resistors further includes an EVSE side resistor on an EVSE side of the control pilot circuit.

9. The method of claim 7, wherein the plurality of resistors further includes a second EV side resistor at the EV side of the control pilot circuit.

10. The method of claim 1, wherein the unlocking the chargeplug from the electrified vehicle in response to receiving the indication includes waiting a delay time before unlocking the chargeplug such that the chargeplug is able to be safely removed.

11. A vehicle inlet of a control pilot circuit for an electrified vehicle, the vehicle inlet including a pair of parallelly arranged resistors and a switch disposed between the pair, the vehicle inlet is configured to lockingly engage with a chargeplug of an Electric Vehicle Supply Equipment (EVSE) such that the chargeplug autonomously enters an unlocked state when a Charge Control Unit (CCU) has experienced a communication anomaly.

12. The vehicle inlet of claim 11, wherein the communication anomaly indicates that a Charge Control Unit has lost communication with at least one of the EVSE and a System Control Module.

13. The vehicle inlet of claim 12, wherein the communication anomaly is indicated by a control pilot state.

14. The vehicle inlet of claim 13, wherein the vehicle inlet responds to a transition in the control pilot state by actuating the switch.

15. The vehicle inlet of claim 11, wherein the chargeplug autonomously enters the unlocked state after a delay time when the charge control unit has experienced the communication anomaly.

16. A controller for an energy storage system, the controller comprising one or more processors configured to autonomously direct a connectible chargeplug to enter an unlocked state during an active charging session upon receiving an indicator that there has been a communication anomaly related to the active charging session.

17. The controller of claim 16, wherein the controller is configured to communicate with a resistor arrangement having a plurality of states, including an autonomously unlockable state and a locked state, the autonomously unlocked state corresponding to State B1, State B2, or State C.

18. The controller of claim 17, wherein the one or more processors is further configured to implement a delay time before causing the connectible chargeplug to enter the autonomously unlockable state.

19. The controller of claim 16, wherein the controller is integrated into an electrified vehicle.

20. The controller of claim 16, wherein the controller is further configured to be in communication with a control pilot circuit, and wherein the indicator corresponds to a voltage at the control pilot circuit.
